(19) United States
(12) Patent Application Publication
(10) Pub. No.: US 2026/0350960 A1
(43) Pub. Date: Nov. 5, 2026

(54) ELECTRONIC DEVICE, METHOD, AND NON-TRANSITORY COMPUTER-READABLE STORAGE MEDIUM FOR PROTECTING PRIVACY

(71) Applicant: THINKWARE CORPORATION, Seongnam-si (KR)

(72) Inventors: Sukpil KO, Seongnam-si (KR); Jungung HA, Seongnam-si (KR)

(21) Appl. No.: 19/552,348

(22) Filed: Feb. 27, 2026

(30) Foreign Application Priority Data
Feb. 28, 2025 (KR) 10-2025-0026727
Feb. 25, 2026 (KR) 10-2026-0035103

(51) Int. Cl. G06V 10/25; G06T 1/60; G06T 7/12; G06T 7/13

(52) U.S. Cl. CPC G06V 10/25; G06T 1/60; G06T 7/12; G06T 7/13; G06T 2207/30196; G06V 2201/07

(57) ABSTRACT

An electronic device includes a camera, memory, a first processor configured to perform artificial intelligence model-related computations, and a second processor configured to compress first video data obtained from the camera. The first processor is configured to receive the first video data from the camera, identify a subject area within the first video data by performing object recognition using the first video data, and transmit information related to the subject area to the second processor. The second processor is configured to, receive the first video data from the camera, receive the information from the first processor, combine a mask object corresponding to the subject area indicated by the information with the first video data, generate second video data by compressing the first video data with which the mask object is combined, and store the second video data in the memory.

### TECHNICAL FIELD

The present disclosure relates to an electronic device, a method, and a non-transitory computer-readable storage medium for protecting privacy.

### BACKGROUND

Recently, technology for capturing, storing, and/or transmitting image data via an electronic device including a camera has been utilized in various fields. However, a captured image may include a face of a person or identifiable information. In particular, a technical measure for effectively protecting privacy information is required in a process in which an image is transmitted to the outside or stored.

The above-described information may be provided as a related art for the purpose of helping understanding of the present disclosure. No argument or decision is made as to whether any of the above description may be applied as a prior art related to the present disclosure.

### SUMMARY

An electronic device is described. The electronic device may comprise a camera, memory, a first processor configured to perform artificial intelligence model-related computations, and a second processor configured to compress first video data obtained from the camera. The first processor may be configured to receive the first video data from the camera, identify a subject area within the first video data by performing object recognition using the first video data, and transmit information related to the subject area to the second processor. The second processor may be configured to, receive the first video data from the camera, receive the information from the first processor, combine a mask object corresponding to the subject area indicated by the information with the first video data, generate second video data by compressing the first video data with which the mask object is combined, and store the second video data in the memory.

A method is described. The method may be executed by an electronic device including a camera, a first processor configured to perform artificial intelligence model-related computations, and a second processor configured to compress first video data obtained from the camera. The method may comprise, by controlling the first processor, receiving the first video data from the camera, identifying a subject area within the first video data by performing object recognition using the first video data, and transmitting information related to the subject area to the second processor. The method may comprise, by controlling the second processor, receiving the first video data from the camera, receiving the information from the first processor, combining a mask object corresponding to the subject area indicated by the information with the first video data, generating second video data by compressing the first video data with which the mask object is combined, and storing the second video data in memory.

A non-transitory computer-readable storage medium is described. The non-transitory computer-readable storage medium may store one or more programs. The non-transitory computer-readable storage medium may be executed by an electronic device including a camera, a first processor configured to perform artificial intelligence model-related computations, and a second processor configured to compress first video data obtained from the camera. The one or more programs may include instructions that cause the electronic device to control the first processor to receive the first video data from the camera, identify a subject area within the first video data by performing object recognition using the first video data, and transmit information related to the subject area to the second processor, and control the second processor to receive the first video data from the camera, receive the information from the first processor, combine a mask object corresponding to the subject area indicated by the information with the first video data, generate second video data by compressing the first video data with which the mask object is combined, and store the second video data in memory.

### BRIEF DESCRIPTION OF DRAWINGS

FIG. 1 is a simplified block diagram of an electronic device of the present invention.

FIG. 2 illustrates an image corresponding to first video data obtained via a camera module of FIG. 1.

FIG. 3 illustrates an embodiment of performing object recognition on an image of FIG. 2.

FIG. 4A illustrates an image corresponding to second video data generated by combining a mask object with a subject area of an image of FIG. 2.

FIG. 4B illustrates an image corresponding to fourth video data generated by deleting image data corresponding to a subject area of an image of FIG. 2.

FIG. 5 is a flowchart representing an operation of an electronic device of FIG. 1.

FIG. 6 is a flowchart representing an operation of an electronic device when a play input is obtained.

FIG. 7 is a flowchart representing an operation of an electronic device when a transmission input is obtained.

FIG. 8 is a flowchart representing an embodiment of generating fourth video data by deleting image data of a subject area.

FIG. 9 illustrates an example of a block diagram illustrating an autonomous driving system of a vehicle according to an embodiment.

FIG. 10 and FIG. 11 illustrate an example of a block diagram representing an autonomous driving mobile body according to an embodiment.

FIG. 12 illustrates an example of a gateway related to a user device according to various embodiments.

FIG. 13 is a diagram for describing an operation of an electronic device training a neural network based on a set of training data according to an embodiment.

FIG. 14 is a block diagram of an electronic device according to an embodiment.

### DETAILED DESCRIPTION

In the following drawings, identical, similar, or corresponding reference numerals may be assigned to an identical, similar, or corresponding configuration, and duplicated descriptions thereof may not be repeated. In the description with reference to a specific drawing below, reference numerals of other drawings may be referred to.

In the present specification, an expression “A, B, or C (A, B, or C)” is used in an inclusive sense including “A”, “B”, “C”, or “any combination thereof”, unless clearly stated otherwise in the context. In addition, an expression “at least one of A, B, and C” should be interpreted to include a meaning including “A alone”, “B alone”, “C alone”, or “any combination of two or more of A, B, and C”, and selectively including respective components, even though a grammatical conjunction ‘and’ is used. Furthermore, such a definition is applied in the same manner even in a case that the number of the described elements is three or more.

In the present disclosure, a description “A, B, and/or C” is merely a simplified expression for brevity of a sentence, and should be interpreted as being identical to a case in which each of “A alone”, “B alone”, “C alone”, “A and B”, “A and C”, “B and C”, and “A, B, and C as a whole” is individually and specifically described. For example, a description that a component includes “A, B, and/or C” should be interpreted as being identical to that the component may selectively include “A”, may include “B”, may include “C”, may include “A and B”, may include “A and C”, may include “B and C”, or may include “A, B, and C”.

In the present disclosure, a singular expression includes a plurality of objects, unless clearly indicated otherwise in the context, and a plural expression is also intended to include a singular object, unless clearly indicated otherwise in the context. For example, a reference to “an element” includes “one or more elements”, and a reference to “elements” may include “one element”.

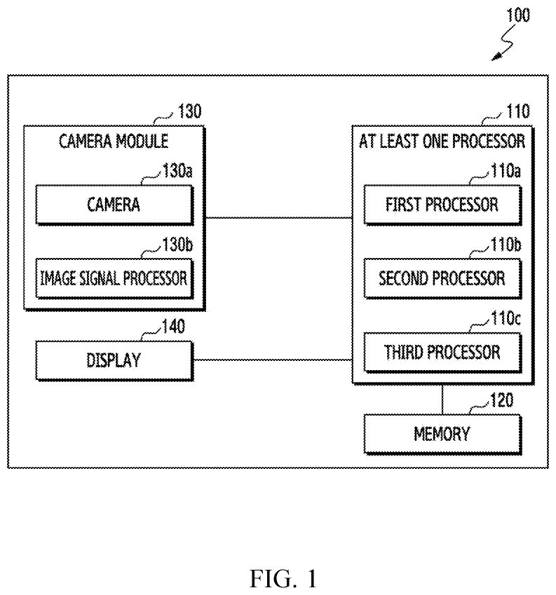

FIG. 1 is a simplified block diagram of an electronic device of the present invention.

Referring to FIG. 1, an electronic device 100 may include at least one processor 110, memory 120, a camera module 130, and a display 140. An embodiment of the present disclosure is not limited thereto. The electronic device 100 may further include other components in addition to the above-described components.

The at least one processor 110 may be an application processor (AP) implemented as a system-on-chip (SoC) in the electronic device 100, but is not limited thereto. The at least one processor 110 may perform operations according to embodiments of the present disclosure by executing instructions stored in the memory 120.

In an embodiment, the at least one processor 110 may include a first processor 110a, a second processor 110b, and a third processor 110c.

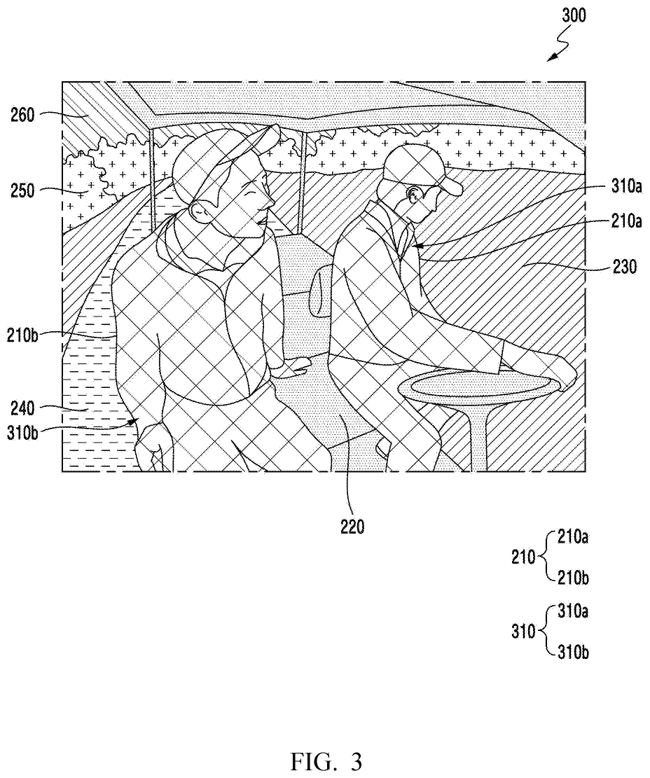

The first processor 110a may be a processor configured to perform artificial intelligence model-related computations. For example, the first processor 110a may be a neural processing unit (NPU). The first processor 110a may perform object recognition by using, as an input, video data and/or image data captured and obtained via the camera module 130. Through this, the first processor 110a may identify a subject area (e.g., a first subject area 310 of FIG. 3) in the video data.

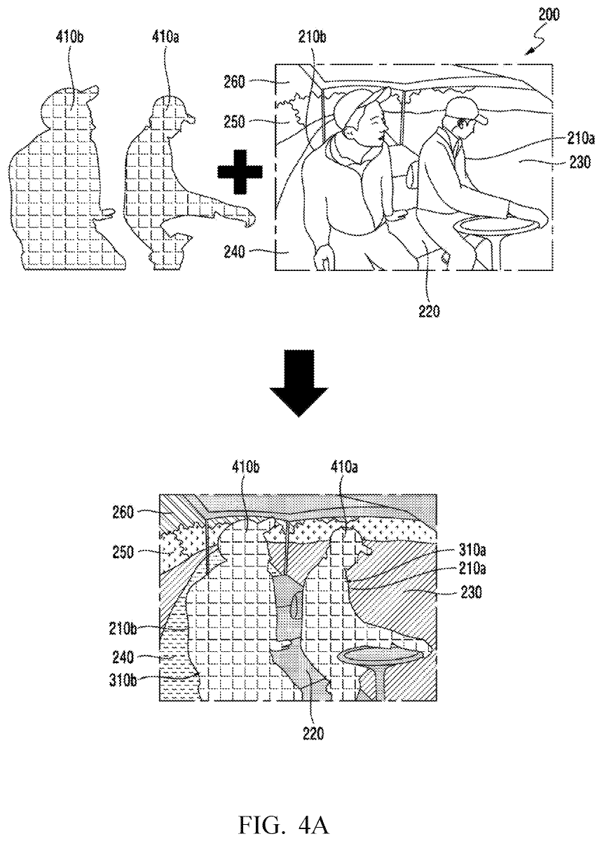

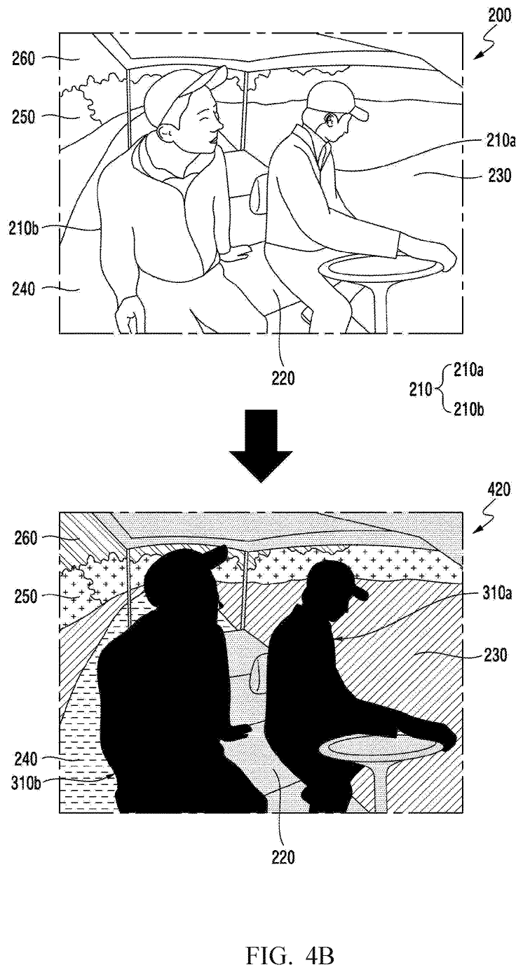

The second processor 110b may be a processor configured to perform compression and/or decompression of video data. For example, the second processor 110b may be a video codec. The second processor 110b may receive video data obtained from the camera module 130, and may combine a mask object (e.g., a mask object 410 of FIG. 4A) corresponding to the subject area 310 in the video data based on information related to the subject area 310 transmitted from the first processor 110a. Thereafter, the second processor 110b may generate privacy-protected video data by compressing the video data with which the mask object 410 is combined, and may store this in the memory 120.

The third processor 110c may perform a general operation and a control function of the electronic device 100. The third processor 110c may be a central processing unit (CPU). For example, the third processor 110c may control an operation related to playback, storage, or transmission to an external electronic device of video data according to a user input. The third processor 110c may control a compression or decompression operation of the second processor 110b.

The memory 120 may include one or more storage media, and may store instructions executed by the processor 110. The memory 120 may store various programs and data executed by the at least one processor 110. For example, the memory 120 may include a volatile memory such as a random-access memory (RAM), and/or a non-volatile memory such as read-only memory (ROM). The volatile memory may include, for example, at least one of a dynamic RAM (DRAM), a static RAM (SRAM), a cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, and an embedded multimedia card (EMMC).

The camera module 130 may generate video data or image data processable inside the electronic device 100 by capturing an image of an external environment. The camera module 130 may output the captured image in a form of an electrical signal, and may transmit it to the at least one processor 110 or the memory 120.

In an embodiment, the camera module 130 may include a camera 130a and an image signal processor (ISP) 130b.

The camera 130a may generate raw image data by receiving external light and converting this into an electrical signal on an image sensor. For example, the camera 130a may output image data in a video frame unit by capturing an external image including a person, an object, or a surrounding environment.

The image signal processor 130b may process the raw image data output from the camera 130a, and may convert it into video data or image data capable of subsequent processing. For example, the image signal processor 130b may perform image signal processing such as mosaicing, noise removal, color correction, gamma correction, and/or resolution conversion. The video data processed via the image signal processor 130b may be transmitted to the first processor 110a and/or the second processor 110b.

The display 140 may provide a user interface (UI) of the electronic device 100. The display 140 may provide visual information to a user of the electronic device 100. In an embodiment, the display 140 may display an image, a video, or a graphic object according to control of the third processor 110c. For example, the display 140 may display an image corresponding to video data stored in the memory 120, or may display a user interface element related to video playback.

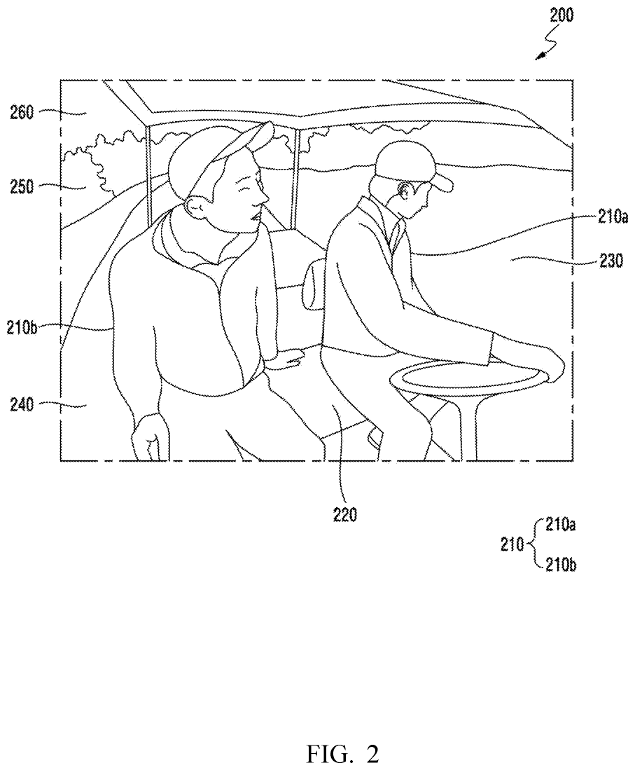

FIG. 2 illustrates an image corresponding to first video data obtained via a camera module of FIG. 1. Specifically, an image 200 illustrated in FIG. 2 represents, for convenience of description, an image corresponding to a video frame at a specific time point of first video data. For example, FIG. 2 illustrates an image in a state in which an occupant is riding in an interior of a vehicle.

Referring to FIG. 2, a camera module 130 may be configured to capture the interior of the vehicle by being disposed to face the interior of the vehicle. The camera module 130 may be referred to as an internal camera or an internal dashcam.

The image 200 captured and obtained via the camera module 130 may include a plurality of visual objects. The plurality of visual objects may include first to sixth visual objects 210, 220, 230, 240, 250, and 260.

For example, the first visual object 210 may correspond to an occupant riding in the interior of the vehicle. For example, the first visual object 210 may include a 1-1 visual object 210a corresponding to an occupant riding in a driver seat and a 1-2 visual object 210b corresponding to an occupant riding in a passenger seat. However, the first visual object 210 may include one visual object or three or more visual objects. The first visual object 210 may include privacy data including a face of the occupant. The first visual object 210 may be referred to as a privacy object.

The second visual object 220 may correspond to configurations in the interior of the vehicle. For example, the second visual object 220 may be an object corresponding to a seat, a steering wheel, and the like in the interior of the vehicle. The third visual object 230 may correspond to grass. The fourth visual object 240 may correspond to a road. The fifth visual object 250 may correspond to a tree. The sixth visual object 260 may correspond to sky. The second to sixth visual objects 220, 230, 240, 250, and 260 may each be referred to as a non-privacy object.

After obtaining the first video data via the camera module 130, when the first video data including the first visual object 210 is transmitted as it is to an external electronic device, there is a possibility that privacy data may be leaked to the outside. For example, the external electronic device may be a device of a third party unrelated to a user, or may be a server accessible via a network. In this case, privacy data such as a face of the occupant may be unintentionally exposed to the outside.

In addition, in a process in which the first video data is copied to or stored in an external electronic device, when a separate protection measure for a privacy object (e.g., the first visual object 210) is not performed, a possibility exists that privacy data is played, analyzed, or retransmitted. In a case of video data including a private space of an individual, such as an image captured in the interior of the vehicle, there is a possibility of violating a personal information protection law and the like, and thus a need for technology for preventing a privacy object (e.g., the first visual object 210) from being exposed to the outside is emerging.

Therefore, the present disclosure may disclose technology for identifying, among first video data including the plurality of visual objects 210, 220, 230, 240, 250, and 260 as illustrated in FIG. 2, the first visual object 210 corresponding to privacy data, and selectively performing masking processing (e.g., refer to FIG. 4A) or deletion processing (e.g., refer to FIG. 4B) on the first visual object 210. Accordingly, when the first video data is transmitted to an external electronic device, leakage of privacy data may be prevented.

FIG. 3 illustrates an embodiment of performing object recognition on an image of FIG. 2. A description with reference to FIG. 3 may partially overlap a description with reference to FIG. 2. Therefore, an overlapping content may be omitted or simplified.

An image 300 illustrated in FIG. 3 represents a result of expressing a plurality of visual objects included in the image 200 of FIG. 2 by distinguishing them from each other. More specifically, the image 300 of FIG. 3 illustrates an embodiment of performing object recognition for identifying a boundary of each of visual objects included in first video data and distinguishing each of visual objects 210, 220, 230, 240, 250, and 260 according to the boundary. More specifically, the image 300 of FIG. 3 illustrates an embodiment of performing object recognition for example, image segmentation, for identifying the boundary of each of the visual objects included in the first video data and segmenting each of the visual objects 210, 220, 230, 240, 250, and 260 according to the boundary.

Referring to FIG. 3, a first processor (e.g., the first processor 110a of FIG. 1) may distinguish areas corresponding to a shape of a person, an interior structure of a vehicle, and/or an exterior background of the vehicle included in the first video data as different visual objects. The first processor 110a may perform an object recognition operation on the visual objects 210, 220, 230, 240, 250, and 260.

The boundary of each of the visual objects 210, 220, 230, 240, 250, and 260 may be identified so that they may be distinguished from an adjacent area. The boundary may represent area separation between adjacent visual objects. For example, as illustrated in FIG. 3, the first visual objects 210a and 210b corresponding to a shape of a person may have a boundary distinguished from the second to fifth visual objects 220, 230, 240, 250, and 260 corresponding to the interior structure of the vehicle or a background. That is, the first processor 110a may perform the object recognition by identifying a boundary distinguishing a subject area 310 and a background area surrounding at least a portion of the subject area 310.

In an embodiment, the first processor 110a may define the subject area 310 corresponding to the first visual object 210. For example, the subject area 310 may include a 1-1 subject area 310a corresponding to the 1-1 visual object 210a. The subject area 310 may include a 1-2 subject area 310b corresponding to the 1-2 visual object 210b. The subject area 310 may be an area corresponding to a privacy object. The subject area 310 may be referred to as a privacy area. For example, the subject area 310 may be an area including a face of an occupant, a part of a body, or a shape capable of identifying an individual. The subject area 310 may be a portion of the first video data determined as capturing a person.

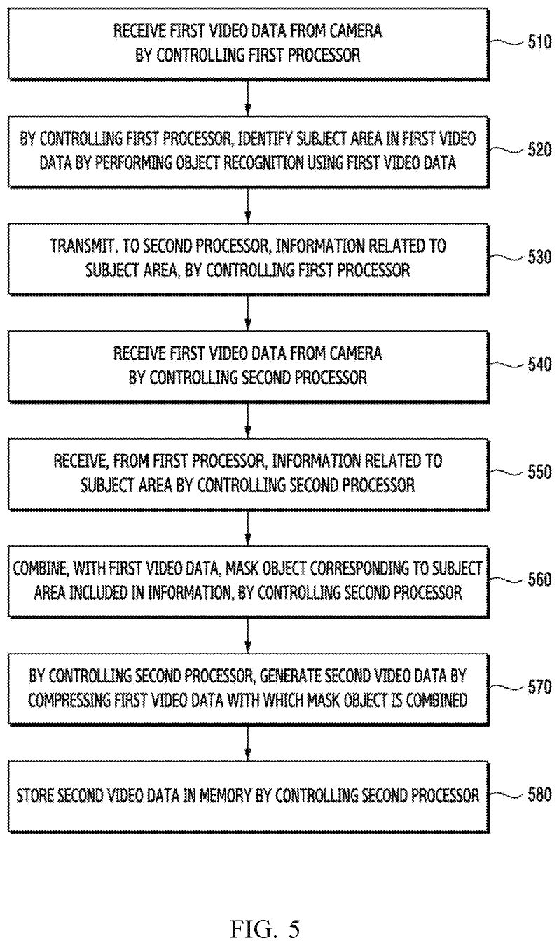

The first processor 110a may distinguish an area requiring privacy protection and an area not requiring it in the first video data by defining the subject area 310. Accordingly, the first processor 110a may generate boundary information distinguishing the subject area 310 and a non-privacy area. The boundary information may be information having a form of a boundary distinguishing the subject area 310 and the background area, and the information transmitted to a second processor 110b may be configured to indicate a mask object having a form of the boundary. The boundary information may be utilized as information for generating a mask object (e.g., a mask object 410 of FIG. 4A) on the first video data or deleting image data (e.g., an embodiment of FIG. 5).

According to an embodiment of the present disclosure, by distinguishing the visual objects as described above, it may clearly distinguish a visual object corresponding to privacy information and a non-privacy object. For example, the first visual object corresponding to the shape of the person may be identified as a subject area requiring privacy protection, and visual objects corresponding to the interior structure of the vehicle or the exterior background may be classified as a non-privacy area.

The object recognition illustrated in FIG. 3 may be performed by the first processor 110a. The first processor 110a may transmit information related to the subject area 310 to the second processor (e.g., the second processor 110b of FIG. 1). The first processor 110a may transmit, to the second processor 110b, information on the subject area 310 obtained by performing object recognition. The second processor 110b receiving the information on the subject area 310 may perform an operation for privacy of the first visual object 210. Hereinafter, with reference to FIGS. 4A and 4B, an operation of the second processor 110b receiving the information on the subject area 310 will be described.

FIG. 4A illustrates an image corresponding to second video data generated by combining a mask object with a subject area of an image of FIG. 2. A description with reference to FIG. 4A may partially overlap a description with reference to FIG. 3. Therefore, an overlapping content may be omitted or simplified.

Referring to FIG. 4A, a second processor 110b may generate a mask object 410 corresponding to a subject area 310. For example, the second processor 110b may generate a 1-1 mask object 410a corresponding to a 1-1 subject area 310a. The second processor 110b may generate a 1-2 mask object 410b corresponding to a 1-2 subject area 310b.

In an embodiment, the mask object 410 may be an object for causing it difficult to visually identify the subject area 310. For example, the mask object 410 may be disposed at a position corresponding to the subject area 310, and may be configured to protect privacy by transforming or covering image information of the corresponding area. For example, the mask object 410 may be a translucent object for mosaic processing. For example, the mask object 410 may be configured to rearrange a plurality of pixels corresponding to the subject area 310 in a predetermined block unit, or to lower resolution so that a detailed shape of a subject is not identified. However, an embodiment of the present disclosure is not limited thereto. The mask object 410 may be an object for blurring processing, or may be a visual object having a single color or a pattern covering the subject area 310.

In an embodiment, the second processor 110b may generate second video data to which privacy protection is applied, by combining the generated mask object 410 with the subject area 310 on the first video data. Specifically, the second processor 110b may generate the second video data by combining the generated mask object 410 with the subject area 310 on the first video data and then compressing it. As the mask object 410 is combined with the subject area 310, the second video data may maintain a protected state in which privacy information included in the subject area 310 is not identified from the outside. The second video data may include an image 410 in a specific frame. The image 410 of FIG. 4A may be an image corresponding to a video frame at a specific time point of the second video data. The image 410 may indicate a state in which the mask object 410 is combined with the first visual object 210. As the mask object 410 is combined on the first visual object 210, privacy information of the first visual object 210 may not be exposed.

In an embodiment, the mask object 410 may be disposed on a layer positioned on the first visual object 210 corresponding to the subject area 310. The mask object 410 may be disposed on a layer closer to a user of an electronic device 100 than a layer of the first video data. Accordingly, a depth value of the mask object 410 may be smaller than a depth value of the first visual object 210. As the mask object 410 is disposed on the layer positioned on the first visual object 210 corresponding to the subject area 310, the mask object 410 may block the first visual object 210 including the privacy information from being visually exposed to the outside.

In an embodiment, the second processor 110b may store, in memory (e.g., the memory 120 of FIG. 1), the second video data generated by compressing video data with which the mask object 410 is combined. The second video data may be video data to which privacy protection is applied. Meanwhile, the second processor 110b may generate third video data by compressing the first video data as a standalone input without combining the mask object 410. The second processor 110b may store the third video data in the memory 120.

That is, the second processor 110b may be configured to selectively generate and store the second video data to which privacy protection is applied and the third video data to which privacy protection processing is not applied.

FIG. 4B illustrates an image corresponding to fourth video data generated by deleting image data corresponding to a subject area of an image of FIG. 2. A description with reference to FIG. 4B may partially overlap a description with reference to FIG. 4A. Therefore, an overlapping content may be omitted or simplified.

Referring to FIG. 4B, the second processor 110b may identify image data corresponding to a subject area 310 in the first video data by using information related to the subject area 310 received from the first processor 110a. For example, the second processor 110b may identify image data corresponding to a 1-1 subject area 310a and a 1-2 subject area 310b, respectively.

In an embodiment, the second processor 110b may delete the image data corresponding to the identified subject area 310 from the first video data. For example, the second processor 110b may be configured to delete privacy information from the first video data by removing pixel data corresponding to the first visual object 210. Accordingly, privacy information included in the first visual object 210 may be completely removed from the image data.

The second processor 110b may generate fourth video data by compressing video data from which image data corresponding to the first visual object 210 is deleted. The fourth video data may indicate a state in which privacy information is removed compared to the first video data. The fourth video data may be stored in memory (e.g., the memory 120 of FIG. 1) in a state in which the privacy information is removed. The fourth video data may maintain privacy protection even when transmitted to an external electronic device or stored inside a device.

An image 420 illustrated in FIG. 4B may be an image corresponding to a video frame at a specific time point of the fourth video data. The image 420 may indicate a state in which image data of an area corresponding to the first visual object 210 is deleted, and accordingly, the corresponding area may not include a shape of a person or visual information capable of identifying an individual.

According to an embodiment of the present disclosure, unlike a mask object combining method illustrated in FIG. 4A, an image data deleting method illustrated in FIG. 4B may provide stronger privacy protection by fundamentally removing image data including privacy information. This deletion-based method may be selectively applied according to a utilization purpose of an image or a required security level.

FIG. 5 is a flowchart representing an operation of an electronic device of FIG. 1.

Referring to FIG. 5, each of operations illustrated in FIG. 5 may be controlled by a third processor 110c included in an electronic device 100. The third processor 110c, which is a processor corresponding to a central processing unit (CPU), may control an operation of a first processor 110a and a second processor 110b. The third processor 110c may generally manage a video data processing flow for privacy protection.

In the following embodiment, each of operations may be sequentially performed, but is not necessarily sequentially performed. For example, an order of each of operations may be changed, and at least two operations may be performed in parallel.

In operation 510, the third processor 110c may control the first processor 110a to receive first video data from a camera module 130. The first video data may be video data captured and obtained via the camera module 130, and may include image data including a plurality of visual objects (e.g., the first to sixth visual objects 210 and 220 of FIG. 2) such as an interior of a vehicle. For example, the first video data may be a set of video frames including a person, an interior structure of the vehicle, and an exterior background of the vehicle.

In operation 520, the third processor 110c may control the first processor 110a to perform object recognition using the first video data. Specifically, the first processor 110a may identify a subject area (e.g., the subject area 310 of FIG. 3) in the first video data by distinguishing areas corresponding to a shape of the person, the interior structure of the vehicle, and/or a background from each other, which are included in the first video data. The object recognition may be performed by image segmentation or an artificial intelligence model-based object recognition method. The subject area 310 may be an area corresponding to privacy information, and may include, for example, a face of an occupant or a part of a body capable of identifying an individual.

In operation 530, the third processor 110c may control the first processor 110a to transmit information related to the subject area 310 from the first processor 110a to the second processor 110b. The information related to the subject area 310 may include at least one of a position, a size, a shape, or boundary information of the subject area 310. For example, the information may be data including pixel coordinates occupied by the subject area 310 in the first video data.

In operation 540, the third processor 110c may control the second processor 110b to receive the first video data from the camera module 130. At this time, the second processor 110b may receive the first video data in parallel with and/or independently of the first processor 110a. For example, while the first processor 110a performs object recognition, the second processor 110b may perform data processing on the same first video data.

In operation 550, the third processor 110c may control the second processor 110b to receive information related to the subject area 310 transmitted from the first processor 110a. Accordingly, the second processor 110b may receive the subject area 310 requiring privacy protection in the first video data. The second processor 110b may be configured to process the subject area 310 and a non-privacy area by distinguishing them from each other.

In operation 560, the third processor 110c may control the second processor 110b to generate a mask object 410 corresponding to the subject area 310 included in the received information and combine the mask object 410 with the first video data. The mask object 410 may be an object configured to cause it difficult to visually identify the subject area 310. For example, the mask object 410 may be a visual object including mosaic processing, blurring processing, or a translucent pattern. The mask object 410 may be disposed to be aligned with a position corresponding to the subject area 310.

In operation 570, the third processor 110c may control the second processor 110b to generate second video data by compressing the first video data with which the mask object 410 is combined. The second video data may be video data to which privacy protection is applied, and may be configured so that privacy information is not identified even when transmitted to or stored in an external electronic device. The compression may be performed based on a video codec.

In operation 580, the third processor 110c may control the second processor 110b to store the second video data in memory 120. Accordingly, the electronic device 100 may store video data in a state in which privacy information is protected. The second video data may maintain a privacy-protected state even when the data is subsequently played, copied, or externally transmitted.

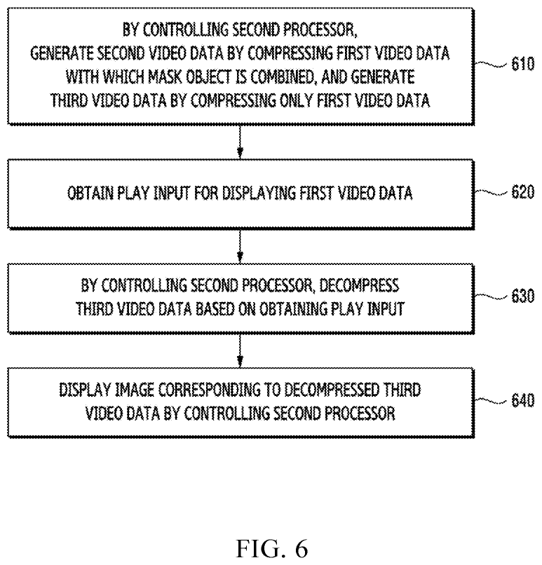

FIG. 6 is a flowchart representing an operation of an electronic device when a play input is obtained.

Referring to FIG. 6, in operation 610, a third processor 110c may control a second processor 110b to generate second video data by compressing first video data with which a mask object 410 is combined. The third processor 110c may control the second processor 110b to generate third video data generated by compressing only the first video data in a state in which the mask object 410 is not combined. The third processor 110c may control the second processor 110b so that it may selectively generate and manage video data to which privacy protection is applied and data corresponding to original video data. The second video data and the third video data may be stored in memory 120.

In operation 620, the third processor 110c may obtain a play input for displaying the first video data. The play input may be an input obtained from a user. For example, the play input may be a touch input, a button input, or a play request signal from an external electronic device. The play input may be an input requesting playback of an original image (e.g., the first video data).

In operation 630, the third processor 110c may control the second processor 110b to decompress the third video data based on obtaining the play input. Since the third video data is data corresponding to the original image to which the mask object 410 is not combined, the decompressed video data may include image data in a state in which privacy protection processing is not applied. The second processor 110b may decompress the third video data by using a video codec.

In operation 640, the third processor 110c may control the second processor 110b to display, via a display 140, an image corresponding to the decompressed third video data. Accordingly, an electronic device 100 may output, to the user, video frames corresponding to the original image. The image displayed via the display 140 may include a plurality of visual objects 210, 220, 230, 240, 250, and 260, such as an image of an interior of a vehicle.

According to an embodiment of the present disclosure, when the play input is obtained as illustrated in FIG. 6, the third processor 110c may selectively decompress and display the third video data corresponding to the original image, other than the second video data to which privacy protection is applied. Accordingly, the electronic device 100 may provide a video management structure in which confirmation of the original image is possible in a playback situation while privacy protection is maintained in a storage step.

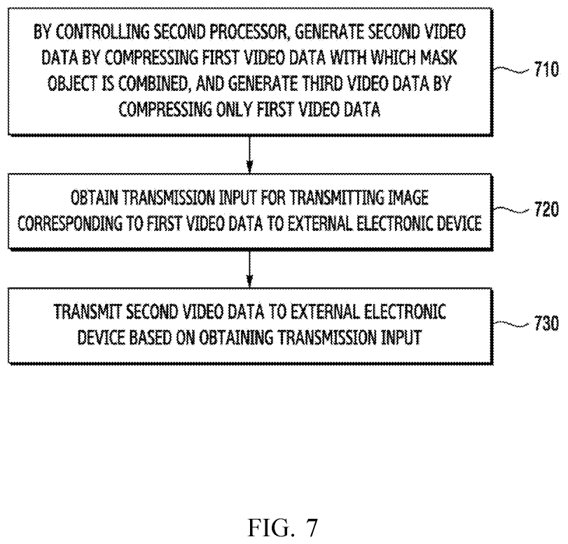

FIG. 7 is a flowchart representing an operation of an electronic device when a transmission input is obtained.

Referring to FIG. 7, in operation 710, a third processor 110c may control a second processor 110b to generate second video data by compressing first video data with which a mask object 410 is combined. In addition, the third processor 110c may control the second processor 110b to generate third video data by compressing only the first video data in a state in which the mask object 410 is not combined. The operation 710 may be substantially the same as the operation 610 of FIG. 6.

In operation 720, the third processor 110c may receive a transmission input for transmitting an image corresponding to the first video data to an external electronic device. The transmission input may be an input received from a user. For example, the transmission input may include a request for sharing a specific video file, an upload request, or a request for transmission to an external electronic device. The external electronic device may be an electronic device of another user different from the user, or may be a server accessible via a network.

In operation 730, the third processor 110c may control the second video data to which privacy protection is applied to be transmitted to the external electronic device based on obtaining the transmission input. Specifically, the third processor 110c may control the second processor 110b or communication circuitry to transmit the second video data to the external electronic device. Accordingly, privacy information corresponding to the subject area 310 may not be exposed in video data transmitted to the external electronic device.

According to an embodiment of the present disclosure, when the transmission input is obtained as illustrated in FIG. 7, the third processor 110c may control the second video data to which privacy protection is applied, other than the third video data corresponding to an original image, to be selectively transmitted. Accordingly, an electronic device 100 may effectively prevent leakage of privacy information in a process of externally transmitting video data, and may block image data capable of identifying an individual from being transmitted to the outside without user consent.

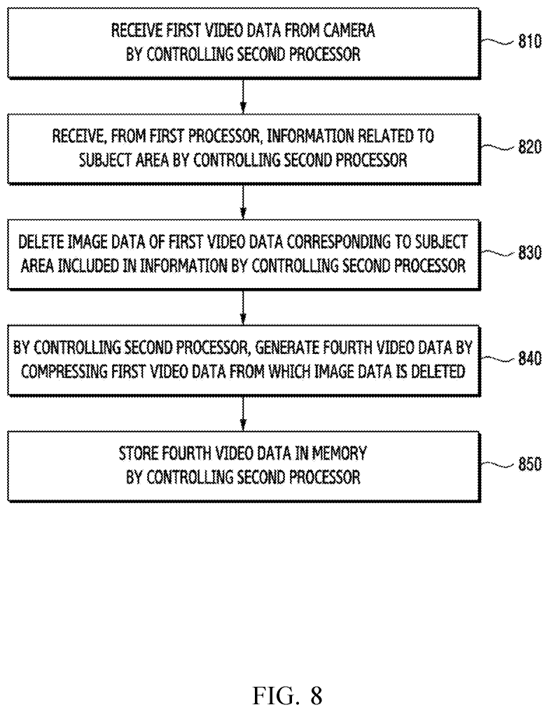

FIG. 8 is a flowchart representing an embodiment of generating fourth video data by deleting image data of a subject area.

Referring to FIG. 8, in operation 810, a third processor 110c may control a second processor 110b to receive the first video data from a camera 140a. The first video data may be video data captured and obtained via a camera module 130, and may include a plurality of visual objects 210, 220, 230, 240, 250, and 260 including a shape of a person and a background.

In operation 820, the third processor 110c may control the second processor 110b to receive information related to a subject area 310 from a first processor 110a. The information related to the subject area 310 may be information on an area requiring privacy protection, and may include, for example, at least one of position information, size information, shape information, or boundary information of the subject area 310.

In operation 830, the third processor 110c may control the second processor 110b to delete image data of the first video data corresponding to the subject area 310 included in the received information. For example, the second processor 110b may fundamentally remove privacy information capable of identifying an individual from the first video data by removing pixel data corresponding to the first visual object 210.

In operation 840, the third processor 110c may control the second processor 110b to generate fourth video data by compressing the first video data from which the image data is deleted. The fourth video data may be video data in a state in which the image data corresponding to the subject area 310 is removed, and may correspond to the fourth video data illustrated in FIG. 4B.

In operation 850, the third processor 110c may control the second processor 110b to store the generated fourth video data in memory 120. Accordingly, an electronic device 100 may store video data in a state in which privacy information is completely removed from image data.

According to an embodiment of the present disclosure, as illustrated in FIG. 8, a method of deleting the image data corresponding to the subject area 310, unlike a method of combining the mask object 410, may provide stronger privacy protection by fundamentally removing image data including privacy information. This deletion-based method may be selectively applied in an environment having a high required security level.

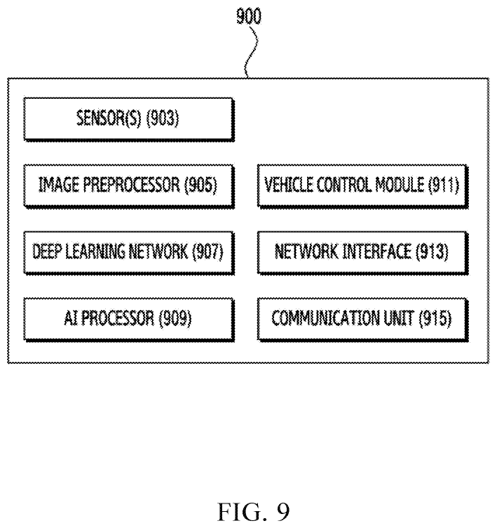

FIG. 9 illustrates an example of a block diagram illustrating an autonomous driving system of a vehicle according to an embodiment.

Referring to FIG. 9, The autonomous driving system 900 of the vehicle according to FIG. 9 may be a deep learning network including sensors 903, an image pre-processor 905, a deep learning network 907, an artificial intelligence (AI) processor 909, a vehicle control module 911, a network interface 913, and a communication unit 915. In various embodiments, each of elements may be connected through various interfaces. For example, sensor data sensed and outputted by the sensors 903 may be fed to the image pre-processor 905. The sensor data processed by the image pre-processor 905 may be fed to the deep learning network 907 run on the AI processor 909. An output of the deep learning network 907 run by the AI processor 909 may be fed to the vehicle control module 911. Intermediate results of the deep learning network 907 run on the AI processor 909 may be fed to the AI processor 909. In various embodiments, the network interface 913 delivers autonomous driving route information and/or autonomous driving control commands for autonomous driving of the vehicle to internal block configurations, by performing communication with an electronic device (e.g., the electronic device 110 of FIG. 2) in the vehicle. In an embodiment, the network interface 913 may be used to transmit the sensor data obtained through the sensor(s) 903 to an external server. In some embodiments, the autonomous driving control system 900 may include additional or fewer components as appropriate. For example, in some embodiments, the image pre-processor 905 may be an optional component. For another example, a post-processing component (not illustrated) may be included in the autonomous driving control system 900 to perform post-processing on the output of the deep learning network 907 before the output is provided to the vehicle control module 911.

In some embodiments, the sensors 903 may include one or more sensors. In various embodiments, the sensors 903 may be attached to different locations of the vehicle. The sensors 903 may face one or more different directions. For example, the sensors 903 may be attached to a front, sides, a rear, and/or a roof of the vehicle to face directions such as forward-facing, rear-facing, and side-facing. In some embodiments, the sensors 903 may be image sensors such as high dynamic range cameras. In some embodiments, the sensors 903 include non-visual sensors. In some embodiments, the sensors 903 include RADAR, Light Detection And Ranging (LiDAR), and/or ultrasonic sensors in addition to an image sensor. In some embodiments, the sensors 903 are not mounted on a vehicle having the vehicle control module 911. For example, the sensors 903 may be included as a portion of a deep learning system for capturing the sensor data and may be attached to an environment or a roadway and/or mounted on nearby vehicles.

In some embodiments, the image pre-processor 905 may be used to pre-process the sensor data of the sensors 903. For example, the image pre-processor 905 may be used to preprocess the sensor data, to split the sensor data into one or more components, and/or to post-process one or more components. In some embodiments, the image pre-processor 905 may be a graphics processing unit (GPU), a central processing unit (CPU), an image signal processor, or a specialized image processor. In various embodiments, the image pre-processor 905 may be a tone-mapper processor for processing high dynamic range data. In some embodiments, the image pre-processor 905 may be a component of the AI processor 909.

In some embodiments, the deep learning network 907 may be a deep learning network for implementing control commands for controlling an autonomous vehicle. For example, the deep learning network 907 may be an artificial neural network such as a convolution neural network (CNN) trained by using the sensor data, and the output of the deep learning network 907 is provided to the vehicle control module 911.

In some embodiments, the artificial intelligence (AI) processor 909 may be a hardware processor for running the deep learning network 907. In some embodiments, the AI processor 909 is a specialized AI processor for performing inference on the sensor data through the convolution neural network (CNN). In some embodiments, the AI processor 909 may be optimized for a bit depth of the sensor data. In some embodiments, the AI processor 909 may be optimized for deep learning computations, such as computations of a neural network including a convolution, a dot product, a vector and/or matrix computations. In some embodiments, the AI processor 909 may be implemented through a plurality of graphics processing units (GPUs) capable of effectively performing parallel processing.

In various embodiments, the AI processor 909 may be coupled, through an input/output interface, to memory configured to perform a deep learning analysis on the sensor data received from the sensor(s) 903 while the AI processor 909 is running and to provide an AI processor having commands that cause to determine a machine learning result used to operate the vehicle at least partially autonomously. In some embodiments, the vehicle control module 911 may be used to process commands for vehicle control outputted from the artificial intelligence (AI) processor 909 and translate the output of the AI processor 909 into commands for controlling a module of each vehicle to control various modules of the vehicle. In some embodiments, the vehicle control module 911 is used to control a vehicle for autonomous driving. In some embodiments, the vehicle control module 911 may adjust steering and/or speed of the vehicle. For example, the vehicle control module 911 may be used to control traveling of the vehicle such as deceleration, acceleration, steering, lane change, lane keeping, and the like. In some embodiments, the vehicle control module 911 may generate control signals for controlling vehicle lighting, such as brake lights, turns signals, headlights, and the like. In some embodiments, the vehicle control module 911 may be used to control vehicle audio-related systems such as a vehicle's sound system, vehicle's audio warnings, a vehicle's microphone system, a vehicle's horn system, and the like.

In some embodiments, the vehicle control module 911 may be used to control notification systems, including warning systems to notify passengers and/or a driver of driving events, such as approach of an intended destination or a potential collision. In some embodiments, the vehicle control module 911 may be used to adjust sensors, such as the sensors 903 of the vehicle. For example, the vehicle control module 911 may modify the orientation of the sensors 903, change output resolution and/or a format type of the sensors 903, increase or decrease a capture rate, adjust a dynamic range, and adjust a focus of the camera. In addition, the vehicle control module 911 may turn on/off the operation of sensors individually or collectively.

In some embodiments, the vehicle control module 911 may be used to change parameters of the image pre-processor 905 in a method such as modifying a frequency range of filters, adjusting features and/or edge detection parameters for object detection, or adjusting channels and a bit depth, and the like. In various embodiments, the vehicle control module 911 may be used to control autonomous driving of the vehicle and/or a driver assistance function of the vehicle.

In some embodiments, the network interface 913 may be responsible for an internal interface between block configurations of the autonomous driving control system 900 and the communication unit 915. Specifically, the network interface 913 may be a communication interface for receiving and/or transmitting data including voice data. According to various embodiments, the network interface 913 may be connected to external servers to connect voice calls, receive and/or transmit text messages, transmit sensor data, update software of the vehicle with the autonomous driving system, or update software of the autonomous driving system of the vehicle, through the communication unit 915.

In various embodiments, the communication unit 915 may include various wireless interfaces of cellular or WiFi methods. For example, the network interface 913 may be used to receive an update on operating parameters and/or commands for the sensors 903, the image pre-processor 905, the deep learning network 907, the AI processor 909, and the vehicle control module 911 from an external server connected through the communication unit 915. For example, a machine learning model of the deep learning network 907 may be updated by using the communication unit 915. According to another example, the communication unit 915 may be used to update operating parameters of the image pre-processor 905, such as image processing parameters, and/or firmware of the sensors 903.

In another embodiment, the communication unit 915 may be used to activate communications for an emergency contact and emergency services in an accident or near-accident event. For example, in a crash event, the communication unit 915 may be used to call emergency services for assistance and may be used to externally notify emergency services of crash details and a location of the vehicle. In various embodiments, the communication unit 915 may update or obtain an expected arrival time and/or a destination location.

According to an embodiment, the autonomous driving system 900 illustrated in FIG. 15 may be configured with an electronic device 110 of the vehicle. According to an embodiment, when an autonomous driving release event occurs from a user during autonomous driving of the vehicle, the AI processor 909 of the autonomous driving system 900 may control the software of the vehicle autonomous driving to learn by controlling information related to the autonomous driving release event to be inputted as training set data of the deep learning network.

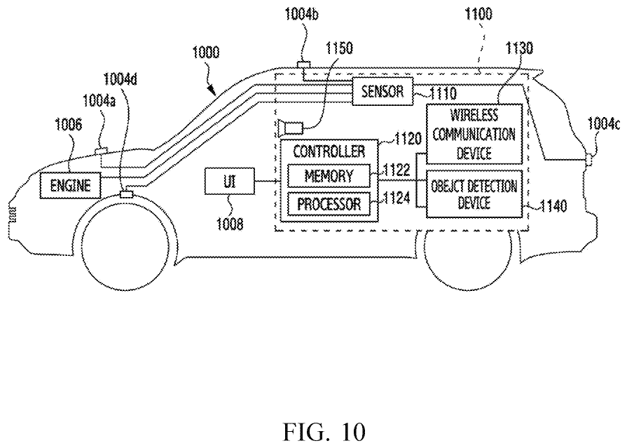

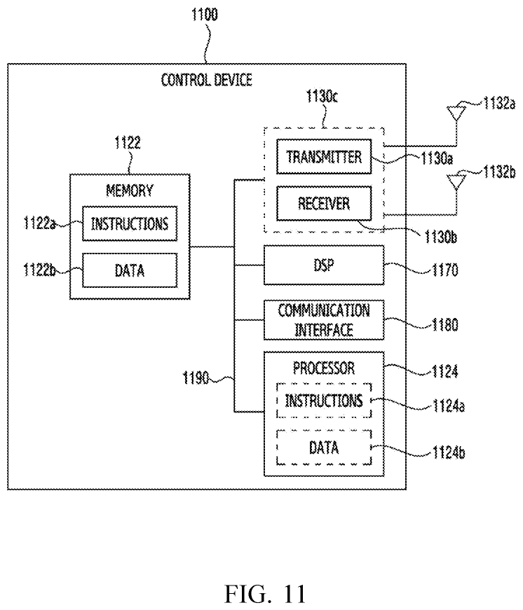

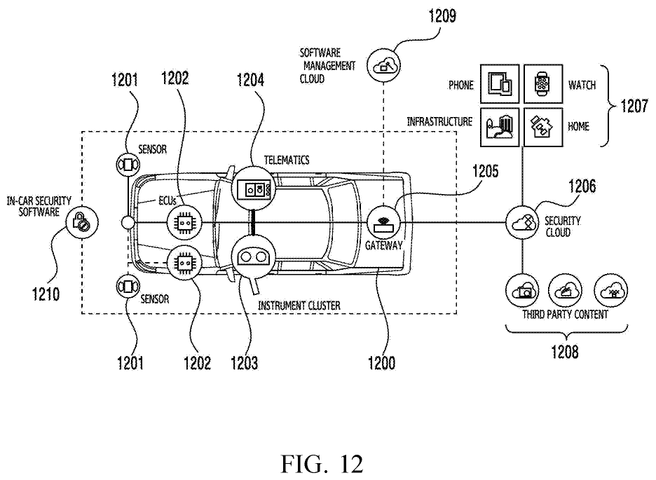

FIGS. 10 and 11 illustrate an example of a block diagram indicating an autonomous driving moving object according to an embodiment. FIG. 12 illustrates an example of a gateway related to a user device according to various embodiments.

Referring to FIG. 10, an autonomous moving object 1000 according to the present embodiment may include a control device 1100, sensing modules 1004a, 1004b, 1004c, and 1004d, an engine 1006, and a user interface 1008.

The autonomous driving moving object 1000 may have an autonomous driving mode or a manual mode. As an example, according to a user input received through the user interface 1008, it may be switched from the manual mode to the autonomous driving mode or may be switched from the autonomous driving mode to the manual mode.

In case that the moving object 1000 operates in the autonomous driving mode, the autonomous driving moving object 1000 may operate under control of the control device 1100.

In the present embodiment, the control device 1100 may include a controller 1120, including memory 1122 and a processor 1124, a sensor 1110, a communication device 1130, and an object detection device 1140.

Herein, the object detection device 1140 may perform all or a portion of a function of a distance measurement device.

That is, in the present embodiment, the object detection device 1140 is a device for detecting an object located outside the moving object 1000, and the object detection device 1140 may detect the object located outside the moving object 1000 and generate object information according to the detection result.

The object information may include information on existence or nonexistence of the object, location information of the object, distance information between the moving object and the object, and relative speed information between the moving object and the object.

The object may include various objects located outside the moving object 1000, such as a lane, another vehicle, a pedestrian, a traffic signal, light, a road, a structure, a speed bump, a landform, an animal, and the like. Herein, the traffic signal may be a concept including a traffic signal, a traffic sign, a pattern or text drawn on a road surface. In addition, the light may be light generated from a lamp equipped in another vehicle, light generated from a streetlamp, or sunlight.

In addition, the structure may be an object located around a road and fixed to the ground. For example, the structure may include a streetlamp, a street tree, a building, a power pole, a traffic light, and a bridge. The landform may include a mountain, a hill, and the like.

Such the object detection device 1140 may include a camera module. The controller 1120 may extract object information from an external image photographed by the camera module and enable the controller 1120 to process information thereon.

In addition, the object detection device 1140 may further include imaging devices for recognizing an external environment. RADAR, a GPS device, Odometry, and another computer vision device, an ultrasonic sensor, and an infrared sensor may be used, in addition to LIDAR, and these devices may be selected or operated simultaneously as needed to enable more precise detection.

Meanwhile, the distance measurement device according to an embodiment of the present invention may calculate a distance between the autonomous driving moving object 1000 and the object, and may control an operation of the moving object based on the distance calculated in connection with the control device 1100 of the autonomous driving moving object 1000.

As an example, in case that there is a probability of a collision according to the distance between the autonomous driving moving object 1000 and the object, the autonomous driving moving object 1000 may control a brake to lower a speed or stop. As another example, in case that the object is a moving object, the autonomous driving moving object 1000 may control a traveling speed of the autonomous driving moving object 1000 to maintain a predetermined distance or more from the object.

This distance measurement device according to an embodiment of the present invention may be configured as a module in the control device 1100 of the autonomous driving moving object 1000. That is, the memory 1122 and the processor 1124 of the control device 1100 may be configured to implement a collision prevention method according to the present invention in software.

In addition, the sensor 1110 may obtain various sensing information by connecting an internal/external environment of the moving object with the sensing modules 1004a, 1004b, 1004c, and 1004d. Herein, the sensor 1110 may include a posture sensor (e.g., a yaw sensor), a roll sensor, a pitch sensor, a collision sensor, a wheel sensor, a speed sensor, a tilt sensor, a weight detection sensor, a heading sensor, a gyro sensor, a position module, a moving object forward/rearward sensor, a battery sensor, a fuel sensor, a tire sensor, a steering sensor by handle rotation, a moving object internal temperature sensor, a moving object internal humidity sensor, an ultrasonic sensor, an illumination sensor, an accelerator pedal position sensor, a brake pedal position sensor, and the like.

Accordingly, the sensor 1110 may obtain sensing signals for moving object posture information, moving object collision information, moving object direction information, moving object location information (GPS information), moving object angle information, moving object speed information, moving object acceleration information, moving object tilt information, moving object forward/rearward information, battery information, fuel information, tire information, moving object lamp information, and moving object internal temperature information, moving object internal humidity information, a steering wheel rotation angle, moving object external illumination, a pressure applied to an accelerator pedal, a pressure applied to a brake pedal, and the like.

In addition, the sensor 1110 may further include an accelerator pedal sensor, a pressure sensor, an engine speed sensor, an air flow sensor (AFS), an intake air temperature sensor (ATS), a water temperature sensor (WTS), a throttle position sensor (TPS), a TDC sensor, a crank angle sensor (CAS), and the like.

As such, the sensor 1110 may generate moving object state information based on sensing data.

The wireless communication device 1130 is configured to implement wireless communication between the autonomous driving moving object 1000. For example, it enables the autonomous driving moving object 1000 to communicate with a mobile phone of a user, or the other wireless communication device 1130, another moving object, a central device (a traffic control device), a server, and the like. The wireless communication device 1130 may transmit and receive a wireless signal according to an access wireless protocol. A wireless communication protocol may be Wi-Fi, Bluetooth, Long-Term Evolution (LTE), Code Division Multiple Access (CDMA), Wideband Code Division Multiple Access (WCDMA), Global Systems for Mobile Communications (GSM), but the communication protocol is not limited thereto.

In addition, in the present embodiment, it is also possible for the autonomous driving moving object 1000 to implement communication between moving objects through the wireless communication device 1130. That is, the wireless communication device 1130 may perform communication with another moving object and other moving objects on the road through vehicle-to-vehicle (V2V) communication. The autonomous driving moving object 1000 may transmit and receive information such as driving warning and traffic information through the vehicle-to-vehicle (V2V) communication, and it is also possible to request information from, or receive a request from the other moving object. For example, the wireless communication device 1130 may perform the V2V communication as a dedicated short-range communication (DSRC) device or a Cellular-V2V (C-V2V) device. In addition, besides the vehicle-to-vehicle (V2V) communication, communication (e.g., Vehicle to Everything communication (V2X)) between a vehicle and another object (e.g., an electronic device carried by a pedestrian, and the like) may also be implemented through the wireless communication device 1130.

In addition, the wireless communication device 1130 may obtain information generated from various mobilities, including infrastructure (a traffic light, a CCTV, a RSU, a eNode B, and the like) located on the road or other autonomous driving/non-autonomous driving vehicles, and the like, through a non-terrestrial network other than a terrestrial network, as information for autonomous driving performance of the autonomous driving moving object 1000.

For example, the wireless communication device 1130 may perform wireless communication through a Low Earth Orbit (LEO) satellite system, a Medium Earth Orbit (MEO) satellite system, a Geostationary Orbit (GEO) satellite system, a High Altitude Platform (HAP) system, and the like, that configure a non-terrestrial network and an antenna dedicated to the non-terrestrial network mounted on the autonomous driving moving object 1000.

For example, the wireless communication device 1130 may perform wireless communication with various platforms configuring the NTN according to a 5TH Generation New Radio Non-Terrestrial Network (5G NR NTN) standard, which is currently discussed in 3GPP, and the like, but is not limited thereto.

In the present embodiment, the controller 1120 may select a platform that may properly perform NTN communication in consideration of various information such as a location of the autonomous driving moving object 1000, current time, and available power, and control the wireless communication device 1130 to perform wireless communication with the selected platform.

In the present embodiment, the controller 1120, which is a unit that controls an overall operation of each unit in the moving object 1000, may be configured by a manufacturer of the moving object when manufacturing or may be additionally configured to perform a function of autonomous driving after manufacturing. In addition, a configuration for performing a continuous additional function may be included through an upgrade of the controller 1120 configured when manufacturing. This controller 1120 may also be named an Electronic Control Unit (ECU).

The controller 1120 may collect various data from the connected sensor 1110, the object detection device 1140, the communication device 1130, and may transmit a control signal to the sensor 1110, the engine 1006, the user interface 1008, the communication device 1130, and the object detection device 1140 included in other components in the moving object based on the collected data. In addition, although not illustrated, the control signal may also be transmitted to an acceleration device, a braking system, a steering device, or a navigation device related to traveling of the moving object.

In the present embodiment, the controller 1120 may control the engine 1006, for example, may detects a speed limit of a road on which the autonomous driving moving object 1000 is traveling, and may control the engine 1006 so that a traveling speed does not exceed the speed limit or may control the engine 1006 to accelerate the traveling speed of the autonomous driving moving object 1000 in a range that does not exceed the speed limit.

In addition, when the autonomous driving moving object 1000 approaches a lane or leaves the lane while the autonomous driving moving object 1000 is traveling, the controller 1120 may determine whether such lane approaching and leaving are due to a normal traveling situation or another traveling situation, and may control the engine 1006 to control the traveling of the moving object according to the determination result. Specifically, the autonomous driving moving object 1000 may detect lanes formed on both sides of the lane in which the moving object is traveling. In this case, the controller 1120 may determine whether the autonomous driving moving object 1000 approaches the lane or leaves the lane, and if it is determined that the autonomous driving moving object 1000 approaches the lane or leaves the lane, the controller 1120 may determine whether this traveling is according to an accurate traveling situation or another traveling situation. Herein, as an example of the normal traveling situation, it may be a situation in which a lane change of the moving object is required. In addition, as an example of the other driving situations, it may be a situation in which a lane change of the moving object is not required. When it is determined that the autonomous driving moving object 1000 is approaching the lane or leaving the lane in a situation in which the moving object does not need to change lane, the controller 1120 may control the traveling of the autonomous driving moving object 1000 so that the autonomous driving moving object 1000 does not leave the lane and normally travels in a corresponding vehicle.

In case that another moving object or an obstacle exists in a front of the moving object, it may control the engine 1006 or the braking system to decelerate the driving moving object, and may control a trajectory, a traveling route, and a steering angle in addition to speed. Alternatively, the controller 1120 may control the traveling of the moving object by generating a necessary control signal according to recognition information of another external environment, such as a traveling lane or a driving signal of the moving object.

In addition to generating its own control signal, the controller 1120 may also control the traveling of the moving object by performing communication with a nearby moving object or a central server and transmitting a command to control peripheral devices through the received information.

In addition, since accurate recognition of the moving object or lane according to the present embodiment may be difficult in case that a location of the camera module 1150 changes or an angle of view changes, the controller 1120 may generate a control signal for controlling to perform calibration of the camera module 1150 to prevent this. Therefore, in the present embodiment, by generating the calibration control signal to the camera module 1150, the controller 1120 may continuously maintain a normal mounting location, a direction, an angle of view, and the like of the camera module 1150 even when a mounting location of the camera module 1150 is changed due to vibration or impact generated by a movement of the autonomous driving moving object 1000. In case that an initial mounting location, a direction, and an angle of view information of the camera module 1150 that are pre-stored, and an initial mounting location, a direction, an angle of view information, and the like of the camera module 1150 measured while the autonomous driving moving object 800 is traveling are changed by a threshold value or more, the controller 1120 may generate the control signal to perform the calibration of the camera module 1150.

In the present embodiment, the controller 1120 may include the memory 1122 and the processor 1124. The processor 1124 may execute software stored in the memory 1122 according to the control signal of the controller 1120. Specifically, the controller 1120 may store data and commands for performing the lane detection method according to the present invention in the memory 1122, and the commands may be executed by the processor 1124 to implement one or more methods disclosed herein.

In this case, the memory 1122 may be stored in a recording medium executable by the non-volatile processor 1124. The memory 1122 may store software and data through an appropriate internal/external device. The memory 1122 may be configured with random access memory (RAM), read only memory (ROM), a hard disk, and a memory 1122 device connected with a dongle.

The memory 1122 may at least store an Operating system (OS), a user application, and executable commands. The memory 1122 may also store application data and array data structures.

The processor 1124, which is a microprocessor or an appropriate electronic processor, may be a controller, a microcontroller, or a state machine.

The processor 1124 may be implemented as a combination of computing devices, and the computing device may be configured with a digital signal processor, a microprocessor, or an appropriate combination thereof.

Meanwhile, the autonomous driving moving object 1000 may further include the user interface 1008 for a user input with respect to the above-described control device 1100. The user interface 1008 may enable a user to input information with appropriate interaction. For example, it may be implemented as a touch screen, a keypad, or an operation button, and the like. The user interface 1008 may transmit an input or a command to the controller 1120, and the controller 1120 may perform a control operation of the moving object in response to the input or the command.

In addition, the user interface 1008, which is a device outside the autonomous driving moving object 1000, may perform communication with the autonomous driving moving object 1000 through the wireless communication device 1130. For example, the user interface 808 may be linkable with a mobile phone, a tablet, or another computer device.

Furthermore, in the present embodiment, the autonomous driving moving object 1000 has been described as including the engine 1006, but it may also include another type of a propulsion system. For example, the moving object may be operated with electrical energy, and may be operated through hydrogen energy or a hybrid system combining them. Therefore, the controller 1120 may include a propulsion mechanism according to the propulsion system of the autonomous driving moving object 1000 and may provide a control signal according to this to components of each propulsion mechanism.

Hereinafter, a detailed configuration of the control device 1100 according to the present invention according to the present embodiment will be described in more detail with reference to FIG. 17.

A control device 1100 includes a processor 1124. The processor 1124 may be a general-purpose single or multi-chip microprocessor, a dedicated microprocessor, a microcontroller, a programmable gate array, and the like. The processor may be referred to as a central processing unit (CPU). In addition, in the present embodiment, it is possible that the processor 1124 is used as a combination of a plurality of processors.

The control device 1100 also includes memory 1122. The memory 1122 may be any electronic component capable of storing electronic information. The memory 1122 may also include a combination of the memories 1122 in addition to single memory.

Data and commands 1122a for performing a distance measuring method of a distance measuring device according to the present invention may be stored in the memory 1122. When the processor 1124 executes the commands 1122a, all or a portion of the commands 1122a and the data 1122b required for performing a command may be loaded 1124a and 1124b onto the processor 1124.

The control device 1100 may include a transmitter 1130a, a receiver 1130b, or a transceiver 1130c for permitting transmission and reception of signals. One or more antennas 1132a and 1132b may be electrically connected to the transmitter 1130a, the receiver 1130b, or each transceiver 1130c, and may further include antennas.

The control device 1100 may include a digital signal processor (DSP) 1170. Through the DSP 1170, the digital signal may be quickly processed by a moving object.

The control device 1100 may include a communication interface 1180. The communication interface 1180 may include one or more ports and/or communication modules for connecting other devices to the control device 1100. The communication interface 1180 may enable a user and the control device 1100 to interact with each other.

Various configurations of the control device 1100 may be connected together by one or more buses 1190, and the buses 1190 may include a power bus, a control signal bus, a state signal bus, a data bus, and the like. Under a control of the processor 1124, configurations may transmit mutual information through the bus 1190 and perform a desired function.

Meanwhile, in various embodiments, the control device 1100 may be related to a gateway for communication with a security cloud. For example, referring to FIG. 12, the control device 1100 may be related to a gateway 1205 for providing information obtained from at least one of components 1001 to 1004 of a vehicle 1200 to a security cloud 1206. For example, the gateway 1205 may be included in the control device 1100. For another example, the gateway 1205 may be configured as a separate device in the vehicle 1200 that is distinguished from the control device 1100. The gateway 1205 connects a network in the vehicle 1200 secured by a software management cloud 1209, the security cloud 1206, and in-car security software 1210, having different networks, to enable communication.

For example, a component 1201 may be a sensor. For example, the sensor may be used to obtain information on at least one of a state of the vehicle 1200 or a state around the vehicle 1200. For example, the component 1201 may include a sensor 1110.

For example, a component 1202 may be electronic control units (ECUs). For example, the ECUs may be used for engine control, transmission control, airbag control, and tire pressure management.

For example, a component 1203 may be an instrument cluster. For example, the instrument cluster may mean a panel located in a front of a driver's seat among dashboards. For example, the instrument cluster may be configured to display information necessary for driving to a driver (or a passenger). For example, the instrument cluster may be used to display at least one of visual elements for indicating a revolutions per minute (or rotates per minute) (RPM) of the engine, visual elements for indicating a speed of the vehicle 1200, visual elements for indicating an amount of remaining fuel, visual elements for indicating a state of a gear, or visual elements for indicating information obtained through the component 1201.

For example, a component 1204 may be a telematics device. For example, the telematics device may mean a device that provides various mobile communication services, such as location information and safe driving in the vehicle 1200 by coupling wireless communication technology and global positioning system (GPS) technology. For example, the telematics device may be used to connect the vehicle 1200 with a driver, a cloud (e.g., the security cloud 1206), and/or a surrounding environment. For example, the telematics device may be configured to support high bandwidth and low latency for 5G NR-standard technology (e.g., V2X technology of the 5G NR, Non-Terrestrial Network (NTN) technology of the 5G NR). For example, the telematics device may be configured to support autonomous driving of the vehicle 1200.

For example, the gateway 1205 may be used to connect a network within the vehicle 1200, and the software management cloud 1209 and the secure cloud 1206, which are a network outside the vehicle. For example, the software management cloud 1209 may be used to update or manage at least one software necessary for traveling and managing the vehicle 1200. For example, the software management cloud 1209 may be linked to the in-car security software 1210 installed in the vehicle. For example, the in-car security software 1210 may be used to provide a security function in the vehicle 1200. For example, the in-car security software 1210 may encrypt data transmitted and received through an in-car network using an encryption key obtained from an external authorized server for encryption of the in-car network. In various embodiments, the encryption key used by the in-car security software 1210 may be generated corresponding to vehicle identification information (a vehicle license plate, a vehicle identification number (VIN)) or information (e.g., user identification information) uniquely assigned to each user.

In various embodiments, the gateway 1205 may transmit the data encrypted by the in-car security software 1210 based on the encryption key to the software management cloud 1209 and/or the security cloud 1206. The software management cloud 1209 and/or the security cloud 1206 may identify the data received from which vehicle or which user by decrypting the data encrypted by the encryption key of the in-car security software 1210. For example, since the decryption key is a unique key corresponding to the encryption key, the software management cloud 1209 and/or the security cloud 1206 may identify a transmission entity (e.g., the vehicle or the user) of the data based on the data decrypted through the decryption key.

For example, the gateway 1205 may be configured to support in-car security software 1210 and may be related to the control device 1100. For example, the gateway 1205 may be related to the control device 1100 to support a connection between a client device 1207 and the control device 1100 connected to the security cloud 1206. For another example, the gateway 1205 may be related to the control device 1100 to support a connection between a third-party cloud 1208 connected to the security cloud 1206 and the control device 1100. However, it is not limited thereto.

In various embodiments, the gateway 1205 may be used to connect the vehicle 1200 with the software management cloud 1209 to manage operating software of the vehicle 1200. For example, the software management cloud 1209 may monitor whether updating the operating software of the vehicle 1200 is required, and based on monitoring that the updating the operating software of the vehicle 1200 is required, provide data for the updating the operating software of the vehicle 1200 through the gateway 1205. For another example, the software management cloud 1209 may receive a user request for updating the operating software of the vehicle 1200 from the vehicle 1200 through the gateway 1205, and provide data for updating the operating software of the vehicle 1200 based on the reception. However, it is not limited thereto.

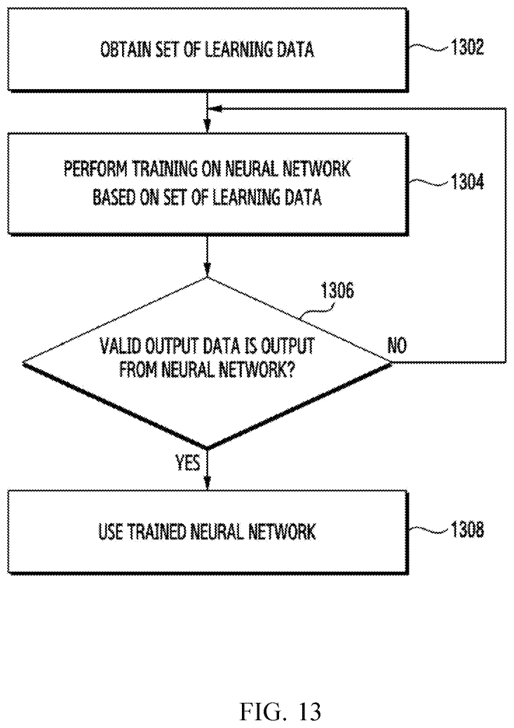

FIG. 13 is a diagram for explaining an operation of an electronic device for training a neural network based on a set of learning data, according to an embodiment.

An operation described with reference to FIG. 13 may be performed by the above-described electronic device (e.g., the electronic device 110 of FIG. 2).

Referring to FIG. 13, in operation 1302, the electronic device may obtain the set of the learning data according to an embodiment. The electronic device may obtain the set of the learning data for supervised learning. The learning data may include a pair of input data and ground truth data corresponding to the input data. The ground truth data may indicate output data to be obtained from the neural network that has received the input data, which is the pair of the ground truth data. The ground truth data may be obtained by the electronic device described above.

For example, in case of training the neural network for image recognition, the learning data may include information regarding an image and one or more subjects included within the image. The information may include a category (or a class) of a subject identifiable through the image. The information may include a location, a width, a height, and/or a size of a visual object corresponding to the subject within the image. The set of the learning data identified through the operation 1302 may include pairs of a plurality of learning data. In the example of training the neural network for the image recognition, the set of the learning data identified by the electronic device may include a plurality of images and ground truth data corresponding to each of the plurality of images.

Referring to FIG. 13, in operation 1304, the electronic device according to an embodiment may perform training on the neural network based on the set of the learning data. In an embodiment in which the neural network is trained based on the supervised learning, the electronic device may input the input data included in the learning data to an input layer of the neural network. An example of the neural network including the input layer will be described with reference to FIG. 15. From an output layer of the neural network receiving the input data through the input layer, the electronic device may obtain output data of the neural network corresponding to the input data.

In an embodiment, the training of the operation 1304 may be performed based on a difference between the output data and the ground truth data included in the learning data and corresponding to the input data. For example, the electronic device may adjust one or more parameters related to the neural network to reduce the difference based on a gradient descent algorithm. An operation of the electronic device adjusting the one or more parameters may be referred to as tuning for the neural network. The electronic device may perform the tuning of the neural network based on the output data using a function defined to evaluate performance of the neural network, such as a cost function. The difference between the output data and the ground truth data may be included as an example of the cost function.

Referring to FIG. 13, in operation 1306, according to an embodiment, the electronic device may identify whether valid output data is outputted from the neural network trained by the operation 1304. The output data being valid may mean that the difference (or the cost function) between the output data and the ground truth data satisfies a condition set for use of the neural network. For example, in case that an average value and/or the maximum value of the difference between the output data and the ground truth data is less than or equal to a designated threshold value, the electronic device may determine that the valid output data is outputted from the neural network.

In case that the valid output data is not outputted from the neural network (1306-NO), the electronic device may repeatedly perform training of the neural network based on the operation 1304. An embodiment is not limited thereto, and the electronic device may repeatedly perform the operations 1302 and 1304.

In a state in which the valid output data is obtained from the neural network (1306-YES), based on operation 1308, the electronic device according to an embodiment may use the trained neural network. For example, the electronic device may input other input data to the neural network that is distinct from the input data inputted to the neural network as the learning data. The electronic device may use output data obtained from the neural network receiving the other input data as a result of performing inference on the other input data based on the neural network.

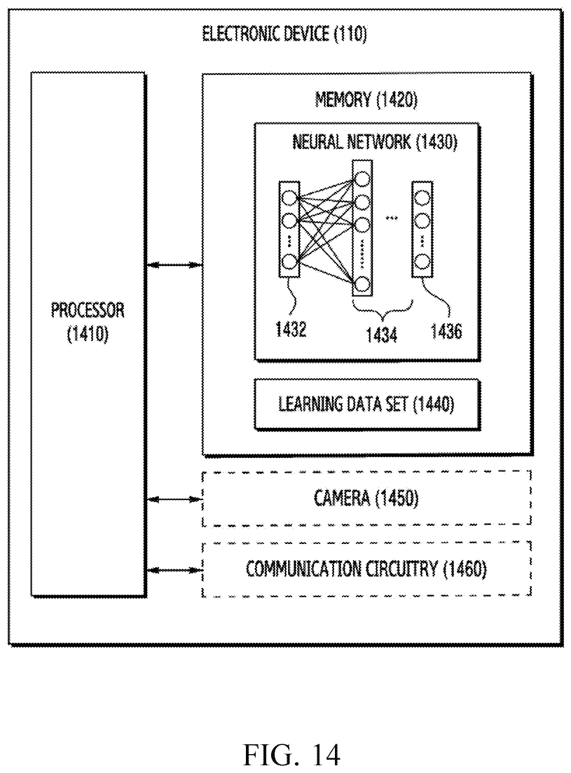

FIG. 14 is a block diagram of an electronic device according to an embodiment.

An electronic device 110 of FIG. 14 may include the above-described electronic device.

For example, an operation described with reference to FIG. 13 may be performed by the electronic device 110 of FIG. 14 and/or a processor 1410 of FIG. 14.

Referring to FIG. 14, the processor 1410 of the electronic device 110 may perform computations related to a neural network 1430 stored in memory 1420. The processor 1410 may include at least one of a center processing unit (CPU), a graphic processing unit (GPU), and a neural processing unit (NPU). The NPU may be implemented as a chip separated from the CPU, or integrated into a chip such as the CPU in a form of a system on a chip (SoC). The NPU integrated into the CPU may be referred to as a neural core and/or an artificial intelligence (AI) accelerator.

Referring to FIG. 14, the processor 1410 may identify the neural network 1430 stored in the memory 1420. The neural network 1430 may include a combination of an input layer 1432, one or more hidden layers 1434 (or intermediate layers), and an output layer 1436. The above-described layers (e.g., the input layer 1432, the one or more hidden layers 1434, and the output layer 1436) may include a plurality of nodes. The number of hidden layers 1434 may vary according to an embodiment, and the neural network 1430 including the plurality of hidden layers 1434 may be referred to as a deep neural network. An operation of training the deep neural network may be referred to as deep learning.

In an embodiment, in case that the neural network 1430 has a structure of a feed forward neural network, a first node included in a specific layer may be connected to all of second nodes included in another layer before the specific layer. In the memory 1420, parameters stored for the neural network 1430 may include weights assigned to connections between the second nodes and the first node. In the neural network 1430 having the structure of the feed forward neural network, a value of the first node may correspond to a weighted sum of values assigned to the second nodes, based on the weights assigned to the connections connecting the second nodes and the first node.

In an embodiment, in case that the neural network 1430 has a structure of a convolutional neural network, the first node included in the specific layer may correspond to a weighted sum of a portion of the second nodes included in the other layer before the specific layer. The portion of the second nodes corresponding to the first node may be identified by a filter corresponding to the specific layer. In the memory 1420, the parameters stored for the neural network 1430 may include weights indicating the filter. The filter may include, among the second nodes, one or more nodes to be used to calculate a weighted sum of the first node, and weights corresponding to each of the one or more nodes.

According to an embodiment, the processor 1410 of the electronic device 110 may perform training on the neural network 1430 using a learning data set 1440 stored in the memory 1420. Based on the learning data set 1440, the processor 1410 may adjust one or more parameters stored in the memory 1420 for the neural network 1430 by performing the operation described with reference to FIG. 13.

According to an embodiment, the processor 1410 of the electronic device 110 may perform object detection, object recognition, and/or object classification using the neural network 1430 trained based on the learning data set 1440. The processor 1410 may input an image (or a video) obtained through a camera 1450 into the input layer 1432 of the neural network 1430. Based on the input layer 1432 to which the image is inputted, the processor 1410 may obtain a set (e.g., the output data) of values of the nodes of the output layer 1436 by sequentially obtaining values of the nodes of the layers included in the neural network 1430. The output data may be used as a result of inferring information included in the image using the neural network 1430. An embodiment is not limited thereto, and the processor 1410 may input an image (or a video) obtained from an external electronic device connected to the electronic device 110 through communication circuitry 1460 to the neural network 1430.

In an embodiment, the neural network 1430 trained to process an image may be used to identify a region corresponding to a subject within the image (object detection), and/or to identify a class of the subject represented within the image (object recognition and/or object classification). For example, the electronic device 110 may segment the region corresponding to the subject within the image based on a quadrangle shape such as a bounding box, using the neural network 1430. For example, the electronic device 110 may identify at least one class matching the subject among a plurality of designated classes using the neural network 1430.

For example, an electronic device may determine a reference position of the second vehicle spaced apart from the first vehicle by a reference distance, and may cause the electronic device to determine a direction in which the camera is directed using the reference position. For example, the electronic device may require a method for obtaining a plurality of first values indicating a size of the second vehicle using the plurality of images obtained using the camera, identify whether a range including second values, which are a portion of the plurality of first values and which are continuously obtained while the plurality of first values are obtained, is maintained until a threshold time elapses, and based on the range maintained until the threshold time elapses: determining the reference position of the second vehicle spaced apart from the first vehicle by the reference distance using position values of the second vehicle respectively associated with the second values, and determining a direction in which the camera is directed, by using the reference position.

As described above, the electronic device may include memory storing instructions. The electronic device may include a camera. The electronic device may include at least one processor. The at least one processor may be configured to obtain a plurality of images using the camera while a relative distance between a first vehicle including the electronic device and a second vehicle different from the first vehicle is changed, obtain a plurality of first values indicating a size of the second vehicle using the plurality of images obtained using the camera, identify whether a range including second values, which are a portion of the plurality of first values and which are continuously obtained while the plurality of first values are obtained, is maintained until a threshold time elapses, and based on the range maintained until the threshold time elapses: determine the reference position of the second vehicle spaced apart from the first vehicle by the reference distance, by using position values of the second vehicle respectively associated with the second values, and determine a direction in which the camera is directed, by using the reference position.

According to an embodiment, an electronic device may cause the electronic device to determine a reference position of the second vehicle spaced apart from the first vehicle by a reference distance, and determine a direction in which the camera is directed by using the reference position. For example, the electronic device may cause the electronic device to obtain a plurality of first values indicating a size of the second vehicle by using the plurality of images obtained using the camera, identify whether a range including second values, which are a portion of the plurality of first values and which are continuously obtained while the plurality of first values are obtained, is maintained until a threshold time elapses, and based on the range maintained until the threshold time elapses: determine the reference position of the second vehicle spaced apart from the first vehicle by the reference distance by using position values of the second vehicle respectively associated with the second values, and determine a direction in which the camera is directed using the reference position.

An electronic device is described. The electronic device may comprise a camera. The electronic device may comprise memory. The electronic device may comprise a first processor configured to perform artificial intelligence model-related computations. The electronic device may comprise a second processor configured to compress first video data obtained from the camera. The first processor may be configured to receive the first video data from the camera, identify a subject area within the first video data by performing object recognition using the first video data, and transmit information related to the subject area to the second processor. The second processor may be configured to, receive the first video data from the camera, receive the information from the first processor, combine a mask object corresponding to the subject area indicated by the information with the first video data, generate second video data by compressing the first video data with which the mask object is combined, and store the second video data in the memory.

For example, the second processor may be configured to generate third video data by compressing the first video data alone, and store the third video data in the memory.

For example, the electronic device may further comprise a display configured to display an image, and a third processor corresponding to a central processing unit (CPU).

For example, the third processor may be configured to obtain a play input for displaying video data, based on obtaining the play input, control the second processor to decompress the third video data, and display an image corresponding to the decompressed third video data via the display.

For example, the third processor may be configured to obtain a transmission input for transmitting an image corresponding to the first video data to an external electronic device, and based on obtaining the transmission input, transmit the second video data to the external electronic device.

For example, the second processor may be configured to delete image data of the first video data corresponding to the subject area, generate fourth video data by compressing the first video data in which the image data is deleted, and store the fourth video data in the memory.

For example, the mask object may be disposed on a layer positioned on the first video data.

For example, the subject area may be a portion of the first video data determined that a person is captured.

For example, the first processor may be configured to perform the object recognition by identifying a boundary that distinguishes the subject area from a background area surrounding at least a portion of the subject area, and the information transmitted to the second processor may be configured to represent the mask object having a shape corresponding to the boundary.

A method is described. The method may be executed by an electronic device including a camera, a first processor configured to perform artificial intelligence model-related computations, and a second processor configured to compress first video data obtained from the camera. The method may comprise, by controlling the first processor, receiving the first video data from the camera, identifying a subject area within the first video data by performing object recognition using the first video data, and transmitting information related to the subject area to the second processor, and by controlling the second processor, receiving the first video data from the camera, receiving the information from the first processor, combining a mask object corresponding to the subject area indicated by the information with the first video data, generating second video data by compressing the first video data with which the mask object is combined, and storing the second video data in memory.

For example, the method may further comprise, by controlling the second processor, generating third video data by compressing the first video data alone, and storing the third video data in the memory.

For example, the electronic device may further comprise a display configured to display an image, and a third processor corresponding to a central processing unit (CPU).

For example, the method may further comprise, by controlling the third processor, obtaining a play input for displaying video data, based on obtaining the play input, controlling the second processor to decompress the third video data, and displaying an image corresponding to the decompressed third video data via the display.

For example, the method may further comprise, by controlling the third processor, obtaining a transmission input for transmitting an image corresponding to the first video data to an external electronic device, and based on obtaining the transmission input, transmitting the second video data to the external electronic device.

For example, the method may further comprise, by controlling the second processor, deleting image data of the first video data corresponding to the subject area, generating fourth video data by compressing the first video data in which the image data is deleted, and storing the fourth video data in the memory.

For example, the mask object may be disposed on a layer positioned on the first video data.

For example, the subject area may be a portion of the first video data determined that a person is captured.

For example, the method may comprise, by controlling the first processor, performing the object recognition by identifying a boundary that distinguishes the subject area from a background area surrounding at least a portion of the subject area, and the information transmitted to the second processor may further comprise representing the mask object having a shape corresponding to the boundary.

A non-transitory computer-readable storage medium is described. The non-transitory computer-readable storage medium may store one or more programs. The non-transitory computer-readable storage medium may be executed by an electronic device including a camera, a first processor configured to perform artificial intelligence model-related computations, and a second processor configured to compress first video data obtained from the camera. The one or more programs may include instructions that cause the electronic device to control the first processor to receive the first video data from the camera, identify a subject area within the first video data by performing object recognition using the first video data, and transmit information related to the subject area to the second processor, and control the second processor to receive the first video data from the camera, receive the information from the first processor, combine a mask object corresponding to the subject area indicated by the information with the first video data, generate second video data by compressing the first video data with which the mask object is combined, and store the second video data in memory.

For example, the one or more programs may include instructions that cause the electronic device to control the second processor to generate third video data by compressing the first video data alone, and store the third video data in the memory.

The technical problems to be achieved in the present disclosure are not limited to those described above, and other technical problems not mentioned herein will be clearly understood by those having ordinary knowledge in the art to which the present disclosure belongs.

1. An electronic device comprising:
a camera;
memory;
a first processor configured to perform artificial intelligence model-related computations; and
a second processor configured to compress first video data obtained from the camera,
wherein the first processor is configured to:
receive the first video data from the camera;
identify a subject area within the first video data by performing object recognition using the first video data; and
transmit information related to the subject area to the second processor, and
wherein the second processor is configured to:
receive the first video data from the camera;
receive the information from the first processor;
combine a mask object corresponding to the subject area indicated by the information with the first video data;
generate second video data by compressing the first video data with which the mask object is combined; and
store the second video data in the memory.

2. The electronic device of claim 1,
wherein the second processor is configured to:
generate third video data by compressing the first video data alone; and
store the third video data in the memory.

3. The electronic device of claim 2 further comprising:
a display configured to display an image; and
a third processor corresponding to a central processing unit (CPU).

4. The electronic device of claim 3,
wherein the third processor is configured to:
obtain a play input for displaying video data;
based on obtaining the play input, control the second processor to decompress the third video data; and
display an image corresponding to the decompressed third video data via the display.

5. The electronic device of claim 3,
wherein the third processor is configured to:
obtain a transmission input for transmitting an image corresponding to the first video data to an external electronic device; and
based on obtaining the transmission input, transmit the second video data to the external electronic device.

6. The electronic device of claim 1,
wherein the second processor is configured to:
delete image data of the first video data corresponding to the subject area;
generate fourth video data by compressing the first video data in which the image data is deleted; and
store the fourth video data in the memory.

7. The electronic device of claim 1, wherein the mask object is disposed on a layer positioned on the first video data.

8. The electronic device of claim 1, wherein the subject area is a portion of the first video data determined that a person is captured.

9. The electronic device of claim 1,
wherein the first processor is configured to:
perform the object recognition by identifying a boundary that distinguishes the subject area from a background area surrounding at least a portion of the subject area, and
wherein the information transmitted to the second processor is configured to represent the mask object having a shape corresponding to the boundary.

10. A method executed by an electronic device including a camera, a first processor configured to perform artificial intelligence model-related computations, and a second processor configured to compress first video data obtained from the camera, the method comprising:
by controlling the first processor:
receiving the first video data from the camera;
identifying a subject area within the first video data by performing object recognition using the first video data; and
transmitting information related to the subject area to the second processor; and
by controlling the second processor:
receiving the first video data from the camera;
receiving the information from the first processor;
combining a mask object corresponding to the subject area indicated by the information with the first video data;
generating second video data by compressing the first video data with which the mask object is combined; and
storing the second video data in memory.

11. The method of claim 10 further comprising:
by controlling the second processor:
generating third video data by compressing the first video data alone; and
storing the third video data in the memory.

12. The method of claim 11, wherein the electronic device further includes:
a display configured to display an image; and
a third processor that is a central processing unit (CPU).

13. The method of claim 12 further comprising:
by controlling the third processor:
obtaining a play input for displaying video data;
based on obtaining the play input, controlling the second processor to decompress the third video data; and
displaying an image corresponding to the decompressed third video data via the display.

14. The method of claim 12 further comprising:
by controlling the third processor:
obtaining a transmission input for transmitting an image corresponding to the first video data to an external electronic device; and
based on obtaining the transmission input, transmitting the second video data to the external electronic device.

15. The method of claim 10 further comprising:
by controlling the second processor:
deleting image data of the first video data corresponding to the subject area;
generating fourth video data by compressing the first video data in which the image data is deleted; and
storing the fourth video data in the memory.

16. The method of claim 10, wherein the mask object is disposed on a layer positioned on the first video data.

17. The method of claim 10, wherein the subject area is a portion of the first video data determined that a person is captured.

18. The method of claim 10 further comprising:
by controlling the first processor, performing the object recognition by identifying a boundary that distinguishes the subject area from a background area surrounding at least a portion of the subject area,
wherein the information transmitted to the second processor represents the mask object having a shape corresponding to the boundary.

19. A non-transitory computer-readable storage medium storing one or more programs, wherein the one or more programs include instructions that, when executed by an electronic device including a camera, a first processor configured to perform artificial intelligence model-related computations, and a second processor configured to compress first video data obtained from the camera, cause the electronic device to:
control the first processor to:
receive the first video data from the camera;
identify a subject area within the first video data by performing object recognition using the first video data; and
transmit information related to the subject area to the second processor; and
control the second processor to:
receive the first video data from the camera;
receive the information from the first processor;
combine a mask object corresponding to the subject area indicated by the information with the first video data;
generate second video data by compressing the first video data with which the mask object is combined; and
store the second video data in memory.

20. The non-transitory computer-readable storage medium of claim 19,
wherein the one or more programs further include instructions that cause the electronic device to:
control the second processor to:
generate third video data by compressing the first video data alone; and
store the third video data in the memory.
